(19) United States
(12) Patent Application Publication
(10) Pub. No.: US 2015/0048552 A1
(43) Pub. Date: Feb. 19, 2015

(54) POLYMER COMPOSITION AND METHOD FOR MANUFACTURING THE SAME

(71) Applicant: CANON KABUSHIKI KAISHA, Tokyo (JP)

(72) Inventors: Yasuhiro Naito, Kawasaki-shi (JP); Isao Hagiwara, Yokohama-shi (JP); Chika Nishi, Yokohama-shi (JP); Kenichiro Iuchi, Newport News (VA); Daisuke Kamei, Yokohama-shi (JP)

(21) Appl. No.: 14/386,055

(22) PCT Filed: Mar. 13, 2013
(86) PCT No.: PCT/JP2013/001645

§ 371 Date: Sep. 18, 2014

(30) Foreign Application Priority Data
Mar. 19, 2012 (JP) 2012-062211
Jan. 22, 2013 (JP) 2013-009525

(51) Int. Cl. C08L 69/00; B29B 17/00; C08L 33/20; B29C 45/00; C08L 55/02; C08L 25/12

(52) U.S. Cl. CPC C08L 69/00; C08L 55/02; C08L 25/12; C08L 33/20; B29C 45/0001; B29B 17/00; B29K 2069/00
USPC 264/328.17; 525/122; 524/502

(57) ABSTRACT

To provide a polymer composition, for example, a polymer composition which contains an alloy resin of polycarbonate and acrylonitrile-butadiene-styrene or acrylonitrile-styrene and in which the impact resistance strength of a degraded thermoplastic resin is improved.

A polymer composition contains polycarbonate and acrylonitrile-butadiene-styrene or acrylonitrile-styrene, and further contains a polyester-based thermoplastic elastomer having an ester bond and a compatibilizing agent having compatibility with the polycarbonate and the acrylonitrile-butadiene-styrene or the acrylonitrile-styrene, in which the compatibilizing agent is a compound having an epoxy group in the main chain in the compound.

### TECHNICAL FIELD

The present invention relates to a polymer composition and a method for manufacturing the same. In particular, the invention relates to a thermoplastic resin composition or an impact resistant thermoplastic composition, but is not limited to one obtained by the use of unused resin, obtained by the use of a degraded resin and applicable to regeneration, and a method for manufacturing the same.

### BACKGROUND ART

In recent years, a tendency of recycling of petrochemicals, particularly recycling of resin materials, has become strong with an increase in environmental conservation awareness. PTL 1 describes, as a method for regenerating a used resin material, a thermal recycling method of utilizing thermal energy generated when subjected to combustion.

In material recycle, a cascading method has been mainly used in which the used materials are converted to materials of products in other fields which have lower quality and do not require functions, such as fire retardancy and strength.

However, in recent years, there is a tendency of regenerating the properties peculiar to resin compositions before regeneration in resin compositions after regeneration to obtain a regenerated resin composition whose properties are close to those of unused resin of the same type.

Heretofore, measures for further increasing the impact resistance of polymer compositions or improving a reduced impact resistance thereof have been taken. PTL 2 describes achieving impact resistance by adding a thermoplastic elastomer, a thermosetting elastomer, or the like alone.

PTL 3 describes achieving impact resistance by increasing the compatibility and the dispersibility of resin by adding a compatibilizing agent alone.

An alloy resin of polycarbonate and acrylonitrile-butadiene-styrene or an alloy resin of polycarbonate and acrylonitrile-styrene shows excellent performance in molding processability, strength, fire retardancy, and the like.

Therefore, these alloy resins are used for many products, such as electrical home appliances, information technology devices, communication facilities, and automobiles. However, the strength, particularly the impact resistance property, of the resins decreases due to degradation caused by hydrolysis and ultraviolet rays during use.

Accordingly, when molded products collected from a market are crushed, and then remolded as they are, it is difficult to obtain molded products having impact resistance strength equivalent to that of molded products obtained using unused resin.

In order to increase the impact resistance of polymer compositions, the methods described in PTL 2 and PTL 3 are mentioned. However, an improvement effect of the impact resistance is not so high, and thus the methods are not sufficient measures.

### CITATION LIST

### Patent Literature

PTL 1: Japanese Patent Laid-Open No. 2000-136393
PTL 2: Japanese Patent Laid-Open No. 6-32912
PTL 3: Japanese Patent Laid-Open No. 2004-182957

### SUMMARY OF INVENTION

The present invention provides a polymer composition, for example, a polymer composition in which the impact resistance strength of a degraded thermoplastic resin containing an alloy resin of polycarbonate and acrylonitrile-butadiene-styrene or acrylonitrile-styrene is improved, and a method for manufacturing the same.

The polymer composition which solves the above-described problems is a polymer composition containing polycarbonate and acrylonitrile-butadiene-styrene or acrylonitrile-styrene, and the polymer composition further contains a polyester-based thermoplastic elastomer having an ester bond and a compatibilizing agent having compatibility with the polycarbonate and the acrylonitrile-butadiene-styrene or the acrylonitrile-styrene, in which the compatibilizing agent is a compound having an epoxy group in the main chain in the compound.

A method for manufacturing the polymer composition which solves the above-described problems includes a process for crushing a molded product containing polycarbonate and acrylonitrile-butadiene-styrene or acrylonitrile-styrene to obtain crushed substances, a process for mixing a polyester-based thermoplastic elastomer having an ester bond and a compatibilizing agent having compatibility with the polycarbonate and the acrylonitrile-butadiene-styrene or the acrylonitrile-styrene and having an epoxy group in the main chain in the compound with the crushed substances to obtain a mixture, and a process for melting and kneading the mixture.

### Advantageous Effects of Invention

The invention can provide a polymer composition, for example, a polymer composition which contains an alloy resin of polycarbonate and acrylonitrile-butadiene-styrene or acrylonitrile-styrene and in which the impact resistance strength is increased to achieve high impact resistance strength and a molded product containing the same.

### BRIEF DESCRIPTION OF DRAWINGS

FIG. 1A illustrates an example of an image formation apparatus having exterior materials that include a plastic containing the polymer composition according to the invention, in which only the exterior materials are illustrated.

FIG. 1B illustrates an example of an image formation apparatus having exterior materials that include a plastic containing the polymer composition according to the invention, in which semi-exterior materials are illustrated.

### DESCRIPTION OF EMBODIMENT

Hereinafter, an embodiment of the invention is described in detail.

The polymer composition according to the invention is a polymer composition containing polycarbonate and acrylonitrile-butadiene-styrene (hereinafter also referred to as ABS) or acrylonitrile-styrene (hereinafter also referred to as AS) and the polymer composition further contains a polyester-based thermoplastic elastomer having an ester bond and a compatibilizing agent having compatibility with the polycarbonate and the acrylonitrile-butadiene-styrene or the acrylonitrile-styrene, in which the compatibilizing agent is a compound having an epoxy group in the main chain in the compound.

A method for manufacturing the polymer composition according to the invention has a process for crushing a molded product containing polycarbonate and acrylonitrile-butadiene-styrene or acrylonitrile-styrene to obtain crushed substances, a process for mixing a polyester-based thermoplastic elastomer having an ester bond and a compatibilizing agent having compatibility with the polycarbonate and the acrylonitrile-butadiene-styrene or the acrylonitrile-styrene and having an epoxy group in the main chain in the compound with the crushed substances to obtain a mixture, and a process for melting and kneading the mixture.

The present inventors have found that, by combining and mixing a thermoplastic elastomer and a compatibilizing agent having a reactive functional group, such as oxazoline groups, epoxy groups, acids, and amino groups, with crushed substances obtained by crushing a molded product of a degraded thermoplastic resin containing an alloy resin of polycarbonate and ABS or AS, a high synergistic effect is obtained and the impact strength sharply increases. In particular, it is suitable to have an epoxy group.

When the compatibilizing agent contains acid, the acid is suitably carboxylic acid and more suitably maleic acid.

The polymer composition according to the invention is a composition having one or a plurality of polymers. The polymer composition may contain a thermoplastic resin composition or an impact resistant thermoplastic resin.

For the polycarbonate and ABS or AS for use in the invention, an unused product of an alloy resin of an aromatic polycarbonate resin and ABS or AS resin or a molded product of a degraded thermoplastic resin containing the alloy resin is used as the raw material, for example. Hereinafter, the following description is given while defining the raw material as the molded product of a degraded thermoplastic resin.

The degraded thermoplastic resin is a thermoplastic resin whose strength decreases due to changes with time, particularly changes in the conditions of light, heat, humidity, and the like. When using the degraded molded product, a regenerated resin can be provided.

As molded products of the degraded thermoplastic resin, a housing, mechanism elements, and the like which are constituent parts of electrical home appliances, information technology devices, communication facilities, automobiles, and the like, for example, and molded products collected from a market after the passage of several years are mentioned.

Then, thermoplastic resin materials obtained by selecting, crushing, and classifying the housing and the mechanism elements are used. With respect to the dimensional size of the crushed resin materials subjected to classification treatment, thermoplastic resin materials are desirable in which the thermoplastic elastomer and the compatibilizing agent component are favorably dispersed and which are crushed in such a manner that the average particle diameter is 10 mm or lower and suitably 3 mm or more and 8 mm or lower in terms of the ease of supplying to a molding machine or a kneading machine.

The crushed and classified alloy resin of an aromatic polycarbonate resin and ABS or AS resin may be an alloy resin of the same grade or a mixed product containing alloy resins of a plurality of grades.

Moreover, a mixed product containing an alloy resin of the same grade and alloy resins of a plurality of grades with different degradation degrees may be acceptable. In order to adjust other physical properties, such as fire retardancy and flowability, an unused product of an alloy resin may be added.

According to the invention, the impact property of the degraded thermoplastic resin composition can be recovered to obtain a regenerated resin. Furthermore, a regenerated resin whose fire retardancy has been recovered can also be obtained.

The polymer composition of the invention further contains, in addition to the degraded thermoplastic resin material, a thermoplastic elastomer and a compatibilizing agent having compatibility with the polycarbonate and the acrylonitrile-butadiene-styrene or the acrylonitrile-styrene.

In order to mix the thermoplastic elastomer component having an ester bond and the compatibilizing agent component with the thermoplastic resin composition, the thermoplastic elastomer component and the compatibilizing agent component suitably have the form of a solid, particularly the form of pellets.

The blending amount of each of the thermoplastic elastomer having an ester bond and the compatibilizing agent to be added to the thermoplastic resin may be adjusted in such a manner as to satisfy a required impact resistance strength.

It is desirable that the content of the thermoplastic elastomer having an ester bond is 0.5 parts by weight or more and 10 parts by weight or lower and suitably 1 part by weight or more and 10 parts by weight or lower based on 100 parts by weight of the thermoplastic resin.

Herein, the thermoplastic elastomer is different from the thermoplastic resin and the thermoplastic elastomer is not contained in 100 parts by weight of the thermoplastic resin.

When the content is lower than 0.5 parts by weight, the blending effect is hardly obtained. When the content exceeds 10 parts by weight, the blending effect is obtained but other physical properties, particularly, bending property, tensile property, and fire retardancy, decrease.

It is desirable that the content of the compatibilizing agent is 0.5 parts by weight or more and 5 parts by weight or lower and suitably 1 part by weight or more and 4 parts by weight or lower based on 100 parts by weight of the thermoplastic resin.

When the content is lower than 0.5 parts by weight, the blending effect of the compatibilizing agent is hardly obtained. When the content exceeds 5 parts by weight, the blending effect is obtained but other physical properties, particularly, bending property, tensile property, and fire retardancy, decrease.

The blending ratio of the thermoplastic elastomer and the compatibilizing agent may be adjusted in such a manner as to satisfy a required impact resistance strength. As the weight ratio, it is desirable that the ratio of the thermoplastic elastomer and the compatibilizing agent is 0.1 or more and 10.0 or lower and suitably 0.2 or more and 5.0 or lower. When the blending ratio is out of this range, the impact resistance improvement effect or the fire retardancy obtained by the use of additives in combination decreases.

The thermoplastic elastomer having an ester bond according to the invention is a polymer substance in which crosslinking is physically established without undergoing vulcanization and shows rubber elasticity at normal temperature.

The thermoplastic elastomer contains a copolymer containing an elastic segment of a rubber component and a hard segment of a resin component.

As a specific example of the thermoplastic elastomer having an ester bond according to the invention, a thermoplastic polyester-based elastomer having an ester bond in the molecule chain is suitable and a polyether ester elastomer having an ether bond and having both hard/soft segments.

Mentioned as the polyester elastomer is a polyether ester block copolymer containing polyester as a hard segment and containing poly(alkylene oxide)glycol as a soft segment or a polyester ester block copolymer containing an aliphatic polyester as a soft segment.

Among the above, the polyether ester elastomer in which the soft segment is a polyether ester block copolymer is suitable.

As the composition ratio of the soft segment and the hard segment of the polyester thermoplastic elastomer, the ratio of the soft segment and the hard segment is 95/5 to 5/95 and particularly suitably 90/10 to 40/60.

Mentioned as a specific example of the polyester thermoplastic elastomer are a polyethylene terephthalate-poly(tetramethylene oxide)glycol block copolymer, a polyethylene terephthalate/isophthalate-poly(tetramethylene oxide)glycol block copolymer, a polybutylene terephthalate-poly(tetramethylene oxide)glycol block copolymer, a polybutylene terephthalate/isophthalate-poly(tetramethylene oxide)glycol block copolymer, a polybutylene terephthalate/decane dicarboxylate-poly(tetramethylene oxide)glycol block copolymer, a polybutylene terephthalate-poly(propylene oxide/ethylene oxide)glycol block copolymer, a polybutylene terephthalate/isophthalate-poly(propylene oxide/ethylene oxide)glycol block copolymer, a polybutylene terephthalate/decane dicarboxylate-poly(propylene oxide/ethylene oxide)glycol block copolymer, a polybutylene terephthalate-poly(ethylene oxide)glycol block copolymer, a polybutylene terephthalate-polyethylene adipate block copolymer, a polybutylene terephthalate-polybutylene adipate block copolymer, a polybutylene terephthalate-polybutylene sebacate block copolymer, a polybutylene terephthalate-poly-epsilon-caprolactone block copolymer, and the like.

Among these polyester thermoplastic elastomers, the polybutylene terephthalate-poly(tetramethylene oxide)glycol block copolymer, the polybutylene terephthalate/isophthalate-poly(tetramethylene oxide)glycol block copolymer, the polybutylene terephthalate/decane dicarboxylate-poly(tetramethylene oxide)glycol block copolymer, the polybutylene terephthalate-poly(propylene oxide/ethylene oxide)glycol block copolymer, the polybutylene terephthalate/isophthalate-poly(propylene oxide/ethylene oxide)glycol block copolymer, the polybutylene terephthalate/decane dicarboxylate-poly(propylene oxide/ethylene oxide)glycol block copolymer, and the polybutylene terephthalate-poly(ethylene oxide)glycol block copolymer are particularly suitable.

These polyester thermoplastic elastomers can be used in combination of two or more kinds thereof as required.

For the compatibilizing agent according to the invention, compounds having compatibility with the polycarbonate and the acrylonitrile-butadiene-styrene or the acrylonitrile-styrene and containing any one of functional groups, such as oxazoline groups, epoxy groups, acids, and amino groups in the main chain in the compounds are used.

The compatibilizing agent having the reactive functional group is suitably one having an epoxy group and more suitably one having a structure in which an epoxy group is present in the main chain skeleton.

The main chain refers to a chain whose length is longer among the chains in the structural formula of the compound having a branched structure and, when the chain length is the same, refers to a molecular chain having a functional group showing the properties of the compound.

The epoxy group establishes pseudo-crosslinking with the thermoplastic resin or the thermoplastic elastomer to thereby increase the reinforcement properties. However, when the epoxy group is present in the side chain, it is considered that the thermoplastic resin or the thermoplastic elastomer cannot be sufficiently reinforced.

Specifically, it is suitable for the compatibilizing agent to have a structure represented by the following Formula I in the unit structure.

—[X]ₐ—[Y_{b}—CH₂CH(O)CH—Z_{c}]_{d}—[W]_{c}— Formula I

(In Formula I, X represents CH₂CR¹R², Y represents CH₂CR³COO, Z represents CH₂, and W represents CH₂CH═CHCH₂. R¹ to R³ each are independently selected from a hydrogen atom, an alkyl group, and a phenyl group. b, c, and e represent an integer of 0 or more and a and d represent an integer of 1 or more. In the case of b is equal to 0, c and e are not equal to 0. In the case of b is not equal to 0, c and e are equal to 0.)

Specifically, as the compatibilizing agent, one having a reactive functional group, such as oxazoline groups, epoxy groups, acids, and amino groups, is mentioned.

More specifically 1,3-phenylene-bis-oxazoline, oxazoline group containing polystyrene, an epoxy group containing acrylate copolymer, an epoxy-modified styrene butadiene block copolymer, carboxylic acid-containing polyolefin, an ethylene maleic acid anhydride ethyl acrylate copolymer, an acid/amine-modified styrene-ethylene-butadiene-styrene copolymer, and the like are mentioned but the compatibilizing agent is not limited thereto. Among the above, one containing an epoxy group is particularly suitable.

Furthermore, one in which an epoxy group is present in the main chain skeleton is suitable. In the case of an acrylate copolymer in which an epoxy group is present in the side chain, sufficient effects are not obtained.

As one in which an epoxy group is present in the main chain skeleton among the substances mentioned above, the ethylene glycidyl methacrylate, the epoxy-modified styrene butadiene block copolymer, and the like are mentioned but such a substance is not limited thereto.

The main resin raw material according to the invention is the alloy resin of polycarbonate and ABS or AS. The invention can be applied to another thermoplastic resin as required insofar as the characteristics of the invention are satisfied.

For example, mentioned are thermoplastic resins, such as low density polyethylene, straight chain low density polyethylene, high density polyethylene, polypropylene (homo, block, and random copolymers), polyamide, polycarbonate, vinyl chloride, polystyrene, methacryl, polyimide, polyamide imide, polyether imide, vinylidene chloride, an ethylene acetic acid vinyl copolymer, ionomer resin, ethylene-ethyl acrylate copolymer resin, acrylonitrile-acrylic rubber-styrene copolymer resin, acrylonitrile-styrene copolymer resin, acrylonitrile-chlorinated polyethylene styrene copolymer resin, acrylonitrile-butadiene-styrene copolymer resin, chlorinated polyethylene, polyacetal resin, polyoxy benzoyl resin, polyetheretherketone resin, polysulfone resin, polyphenylene ether resin, polyphenylene sulfide resin, polybutadiene resin, methylpentene resin, polyvinylidene fluoride, tetrafluoroethylene-ethylene copolymer resin, tetrafluoroethylene-hexafluoropropylene copolymer resin, and ethylene-chlorotrifluoro ethylene copolymer resin, and the like. These resins can be used singly or in combination of two or more kinds thereof. However, the resins are not limited to the materials mentioned above.

In the thermoplastic resin according to the invention, a flame retardant can be blended as required in a range where the purpose of the invention is not impaired.

Mentioned as the flame retardant are flame retardants, such as a halogen-containing compound type, an antimony-containing compound type, a sulfonic acid metal salt type, a nitrogen-containing compound type, a phosphorus-containing compound type, a silicon-containing compound type, and a carbon type, and a carbon-based additive is suitable.

The blending amount of the flame retardant is 0.1 part by weight or more and 5 parts by weight or lower and suitably 0.2 part by weight or more and 1.5 parts by weight or lower based on 100 parts by weight of the thermoplastic resin.

This is because there is a possibility such that when the blending amount is lower than 0.1 part by weight, the blending effect of the flame retardant is not hardly obtained and when the blending ratio exceeds 5 parts by weight, the blending effect is obtained but other physical properties, particularly, impact resistance strength, bending property, and tensile property, decrease.

The thermoplastic resin according to the invention is one having thermoplasticity as a resin mixture. For example, even in the case of a mixture of a thermoplastic resin and a thermosetting resin powder, when the final resin mixture has thermoplasticity, the mixture is referred to as a thermoplastic resin.

In the polymer composition of the invention, stabilizers, antioxidants, ultraviolet absorbers, mold release agents, colorants, inorganic fillers, and the like mentioned bellow can be blended in a range where the purpose of the invention is not impaired.

Mentioned as the stabilizers and antioxidants are, for example, hindered phenol compounds, phosphorus compounds, sulfur compounds, epoxy compounds, hindered amine compounds, and the like.

Mentioned as the ultraviolet absorbers are inorganic ultraviolet absorbers, such as titanium oxide, cerium oxide, and zinc oxide and organic ultraviolet absorbers, such as a benzotriazole compound, a benzophenone compound, and a triazine compound.

Mentioned as the mold release agents is at least one compound selected from aliphatic carboxylic acids, aliphatic carboxylic acid esters, aliphatic hydrocarbon compounds having a number average molecular weight of 200 to 15000, and polysiloxane silicone oil.

Mentioned as the colorants are carbon black, titanium oxide, compounds having an anthraquinone skeleton, compounds having a phthalocyanine skeleton, and the like.

Mentioned as the inorganic filler are glass fibers, glass milled fibers, glass flake, carbon fibers, silica, alumina, titanium oxide, calcium sulfate powder, gypsum, gypsum whiskers, barium sulfate, talc, mica, calcium silicicate, carbon black, graphite, iron powder, copper powder, molybdenum disulfide, silicon carbide, silicon carbide fibers, silicon nitride, silicon nitride fibers, brass fibers, stainless steel fibers, potassium titanate fibers or whiskers, and the like.

The inorganic filler may be subjected to surface treatment with silane coupling agents, such as amino silane and epoxy silane, for the purpose of increasing adhesion with resin or may be subjected to sizing treatment with acrylic resin, urethane resin, or the like for the purpose of increasing the handling properties for use.

Furthermore, additives, such as an antifogging agent, an antiblocking agent, a slip additive, a dispersing agent, a nucleating agent, a foaming agent, a crosslinking agent, an antibacterial agent, and a fluorescent bleaching agent, can be blended as required.

The thermoplastic resin composition according to the invention can be produced by mixing an alloy resin of an unused aromatic polycarbonate and ABS or AS or an alloy resin of a degraded aromatic polycarbonate and ABS or AS, a polyester-based thermoplastic elastomer, a reactive compatibilizing agent, and other additives in such a manner as to form a uniform mixture.

At least one of the polycarbonate and the acrylonitrile-butadiene-styrene or the acrylonitrile-styrene degraded may be a degraded polymer.

For the mixing method, known methods are usable. The thermoplastic resin composition can be prepared by mixing the substances by a blender or the like beforehand, and then mixing the mixed substances by a uniaxial extruder, a biaxial kneading extruder, a Banbury mixer, a roll, Brabender, Plastograph, a kneader, or the like. It is particularly suitable to use one obtained by mixing the substances by a biaxial kneading extruder, and then pelletizing the mixture.

Methods for molding the thermoplastic resin composition according to the invention are, but not limited thereto, injection molding, extrusion molding, sandwich molding, two-color molding, core back molding, compression molding, blow molding vacuum molding, rotation molding, and the like, and the injection molding is more suitable.

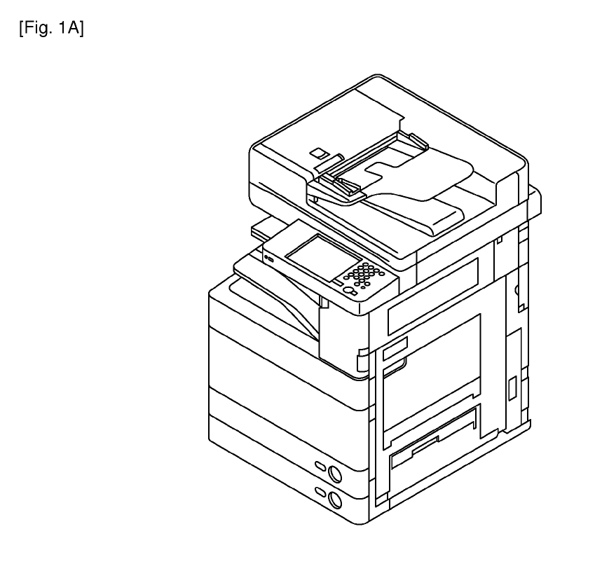

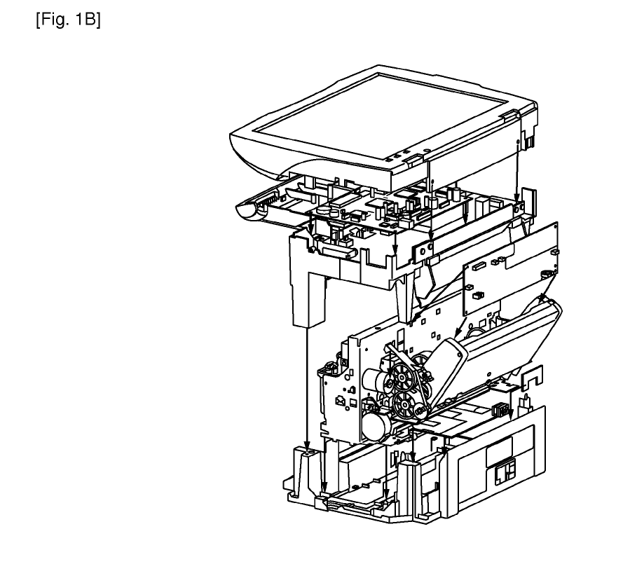

As a molded product containing the thermoplastic resin composition according to the invention, plastic usable as a part of the image formation apparatus illustrated in FIGS. 1A and 1B is mentioned.

As the part of the image formation apparatus, the molded product of the invention may be used for any one of an exterior material, a semi-exterior material, and an interior material. The exterior material is a part also referred to as a housing and refers to a portion which is visible from the outside of the image formation apparatus. On the other hand, the semi-exterior material is a portion inside the image formation apparatus but a portion which is visible from a user when the user uses the same. As the timing when a user sees the semi-exterior material, the timing of paper supplement or the like is mentioned.

FIG. 1A illustrates only the exterior material as an example. FIG. 1B further includes the semi-exterior material as an example. FIGS. 1A and 1B illustrate an example of the image formation apparatus, and the invention is not limited to the aspect of FIG. 1.

The interior material is a portion which is not visible from a user during the use by the user. In the image formation apparatus, plastic members for use in the vicinity of function members, such as a photoconductor, or plastic members for use in the vicinity of supplies, such as a cable guide and a fan duct, are mentioned.

Particularly in the vicinity of a heating element, it is suitable to use materials having high heat resistance.

The plastic according to the invention can be used not only for the image formation apparatus but for housings of image pickup apparatuses, such as cameras, housings of display apparatuses, such as a display of PC, and the like.

### EXAMPLES

Hereinafter, the invention is more specifically described with reference to Examples. However, the invention is not limited to Examples below.

In this example, thermoplastic resin compositions were produced using alloy resins of A component, thermoplastic elastomers of B component, compatibilizing agents of C component, and carbon of D component shown below.

(1) The A component is an alloy resin of aromatic polycarbonate and ABS or AS.

A-1: An alloy resin contains aromatic polycarbonate and AS and is in the form of unused pellets (Size of about 3 mm).

A-2: An alloy resin contains aromatic polycarbonate and AS and is obtained by putting the unused pellets of A-1 above in a thermohygrostat, exposing the same to an environment of a temperature of 65 degrees centigrade and a humidity of 85% for 1000 hours, and then taking out the resultant mixture.

The degradation degree of the resin obtained under the conditions is equivalent to that of an alloy resin of polycarbonate and ABS or AS used for an exterior material of a collected office machine after used from about 5 to about 10 years in a market.

A-3: An alloy resin contains aromatic polycarbonate and AS and is obtained by crushing a molded product used for an exterior material of a collected office machine after used from about 5 to about 10 years in a market, and then sieving the crushed substances through a vibration sieve to select the crushed substances having a particle diameter of 3 mm or more and 8 mm or lower.

(2) The B component is a thermoplastic elastomer.

B-1: Polyether ester elastomer: Hytre 3078 (manufactured by Du Pont-Toray Co., Ltd.)

B-2: Polyether ester elastomer: Pelprene P30B (manufactured by Toyobo Co., Ltd.)

B-3: Butadiene-based elastomer: G1702HU (manufactured by Clayton Polymer Co., Ltd.)

(3) The C component is a compatibilizing agent having an epoxy group.

C-1: Structure in which an epoxy group is present in the main chain, Ethylene glycidyl methacrylate: Bond First E (manufactured by Sumitomo Chemical Co., Ltd.).

C-2: Structure in which an epoxy group is present in the main chain, Epoxidized substance of a copolymer of styrene and butadiene: Epofriend AT501 (manufactured by Daicel Chemical Industries. Ltd.).

C-3: Structure in which an epoxy group is present in the side chain, Acrylic graft polymer; RESEDA GP301 (manufactured by Toagosei Co., Ltd.).

(4) The D component is a carbon-based additive.

D-1: Scale-like graphite BF10A (manufactured by Fuji Kokuen K.K.)

D-2: Artificial graphite AG6T (manufactured by ITO GRAPHITE Co., Ltd)

Next, test pieces were molded from the thermoplastic resin compositions produced by blending the alloy resins of the A component, the thermoplastic elastomers of the B component, the compatibilizing agents of the C component, and, as required, the carbon of the D component. Then, the Charpy impact test, calculation of a rate of increase from the base resin, and a burning test were carried out.

### Charpy Impact Test

The alloy resins of the A component, the thermoplastic elastomers of the B component, the compatibilizing agents of the C component, and, as required, the carbon of the D component were mixed according to predetermined blending amounts shown in the following tables, and then mixed by a biaxial kneading extruder to produce pellets.

The obtained pellets were dried, and then molded into Type-1 test pieces for the Charpy impact tests based on JIS K7111 standard using an injection molding machine.

Thereafter, the test pieces were subjected to cutting processing of Type A notch based on JIS K711, and then the Charpy impact test was carried out using an impact tester. The evaluation results are shown in the following tables.

Rate of Increase from Base Resin

The rate of increase from the base resin is also shown. In Example 1, the value obtained by dividing the value of the Charpy impact strength of Example 1 by the value of the Charpy impact strength of a comparative example containing only the same base resin, i.e., Comparative Example 1, is shown as the rate of increase from the base resin.

Similarly, the value of Example 12 was calculated using the value of Comparative Example 2 and the value of Example 16 was calculated using the value of Comparative Example 3, for example. The evaluation results are shown in the following tables.

### Flammability Test

The alloy resins of the A component, the thermoplastic elastomers of the B component, the compatibilizing agents of the C component, and, as required, the carbon of the D component were mixed according to predetermined blending amounts shown in the following tables, and then mixed by a biaxial kneading extruder to produce pellets.

The obtained pellets were dried, and then molded into test pieces for the V burning test based on the UL94 standard using an injection molding machine.

Thereafter, the test pieces were subjected to the V burning test by a method based on the UL94 standard. The V judging results, the total burning time, and the number of firing drips are shown in the following tables.

TABLE 1

| Ex. | | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| A: Base resin | A1 | 100 | 100 | 100 | 100 | 100 | 100 | 100 | 100 | 100 | 100 | 100 | | | | |
| | A2 | | | | | | | | | | | | 100 | 100 | 100 | 100 |
| | A3 | | | | | | | | | | | | | | | |
| B: Elastomer | B1 | 4 | 4 | | | 5 | 3 | 2 | 1 | 2 | 10 | 10 | 4 | 4 | | |
| | B2 | | | 4 | 4 | | | | | | | | | | 4 | 4 |
| | B3 | | | | | | | | | | | | | | | |
| C: Compatibilizing | C1 | 2 | | 2 | | 1 | 3 | 4 | 5 | 1 | 2 | 4 | 2 | | 2 | |
| agent | C2 | | 2 | | 2 | | | | | | | | | 2 | | 2 |
| | C3 | | | | | | | | | | | | | | | |
| Carbon | D1 | | | | | | | | | | | | | | | |
| | D2 | | | | | | | | | | | | | | | |

| | | | | | | | | | | | | | | | |
|---|---|---|---|---|---|---|---|---|---|---|---|---|---|---|---|
| Charpy impact strength | 55 | 50 | 57 | 55 | 53 | 53 | 50 | 44 | 38 | 62 | 70 | 40 | 40 | 43 | 38 |
| Rate of increase | 4.6 | 4.2 | 4.8 | 4.6 | 4.4 | 44 | 4.2 | 3.6 | 3.1 | 5.2 | 5.8 | 4.4 | 4.4 | 4.8 | 4.2 |
| Fire retardancy | V-1 | V-1 | V-1 | V-1 | V-1 | V-1 | V-1 | V-1 | V-1 | V-1 | V-2 | V-1 | V-1 | V-1 | V-1 |
| Total burning time (s) | 59 | 65 | 48 | 60 | 42 | 66 | 82 | 100 | 21 | 86 | 178 | 49 | 58 | 40 | 55 |
| Number of firing drips | | | | | | | | | | | 4 | | | | |

TABLE 2

| Ex. | | 16 | 17 | 18 | 19 | 20 | 21 | 22 |
|---|---|---|---|---|---|---|---|---|
| A: Base resin | A1 | | | | | | | |
| | A2 | | | | | | | |
| | A3 | 100 | 100 | 100 | 100 | 100 | 100 | 100 |
| B: Elastomer | B1 | 4 | 5 | 2 | 1 | 2 | 10 | 10 |
| | B2 | | | | | | | |
| | B3 | | | | | | | |
| C: Compatibilizing | C1 | 2 | 1 | 4 | 0.5 | 1 | 2 | 4 |
| agent | C2 | | | | | | | |
| | C3 | | | | | | | |
| Carbon | D1 | | | | | | | |
| | D2 | | | | | | | |

| | | | | | | | |
|---|---|---|---|---|---|---|---|
| Charpy impact strength | 65 | 64 | 68 | 56 | 61 | 66 | 65 |
| Rate of increase | 4.3 | 4.3 | 4.5 | 3.7 | 4.1 | 4.4 | 4.3 |
| Fire retardancy | V-2 | V-2 | V-2 | V-2 | V-2 | V-2 | V-2 |
| Total burning time (s) | 176 | 118 | 198 | 119 | 132 | 131 | 193 |
| Number of firing drips | 5 | 5 | 5 | 5 | 5 | 5 | 5 |

TABLE 3

| Ex. | | 23 | 24 | 25 | 26 | 27 | 28 | 29 | 30 | 31 | 32 | 33 | 34 | 35 | 36 | 37 | 38 |
|---|---|---|---|---|---|---|---|---|---|---|---|---|---|---|---|---|---|
| A: Base resin | A1 | | | | | | | 100 | 100 | 100 | 100 | | | | | | |
| | A2 | 100 | 100 | 100 | 100 | 100 | 100 | | | | | | | | | | |
| | A3 | | | | | | | | | | | 100 | 100 | 100 | 100 | 100 | 100 |
| B: Elastomer | B1 | 4 | 4 | 4 | 4 | 4 | 4 | 4 | 4 | 4 | 4 | 4 | 4 | 4 | 4 | 4 | 4 |
| | B2 | | | | | | | | | | | | | | | | |
| | B3 | | | | | | | | | | | | | | | | |
| C: Compatibilizing | C1 | 2 | 2 | 2 | 2 | 2 | 2 | 2 | 2 | 2 | 2 | 2 | 2 | 2 | 2 | 2 | 2 |
| agent | C2 | | | | | | | | | | | | | | | | |
| | C3 | | | | | | | | | | | | | | | | |
| Carbon | D1 | 0.2 | 0.5 | 1.0 | 1.5 | | | 0.5 | 1 | | | 0.2 | 0.5 | 1 | 1.5 | | |
| | D2 | | | | | 0.5 | 1 | | | 0.5 | 1 | | | | | 0.5 | 1 |

| | | | | | | | | | | | | | | | | |
|---|---|---|---|---|---|---|---|---|---|---|---|---|---|---|---|---|
| Charpy impact strength | 38 | 36 | 31 | 24 | 35 | 28 | 47 | 39 | 44 | 39 | 60 | 52 | 44 | 37 | 51 | 40 |
| Rate of increase | 4.2 | 4.0 | 3.4 | 2.7 | 3.9 | 3.1 | 3.8 | 3.3 | 3.6 | 3.2 | 4.0 | 3.5 | 2.9 | 2.5 | 3.4 | 2.7 |
| Fire retardancy | V-1 | V-1 | V-1 | V-1 | V-1 | V-0 | V-1 | V-1 | V-0 | V-1 | V-2 | V-2 | V-2 | V-2 | V-2 | V-2 |
| Total burning time (s) | 55 | 49 | 38 | 30 | 69 | 34 | 68 | 32 | 49 | 28 | 182 | 176 | 159 | 140 | 142 | 144 |
| Number of firing drips | | | | | | | | | | | 5 | 5 | 2 | 2 | 5 | 4 |

TABLE 4

| Ex. | | 39 | 40 | 41 | 42 | 43 | 44 |
|---|---|---|---|---|---|---|---|
| A: Base resin | A1 | 100 | | | 100 | | |
| | A2 | | | | | 100 | |
| | A3 | | 100 | 100 | | | 100 |
| B: Elastomer | B1 | 10 | 1 | 10 | 1 | 4 | 4 |
| | B2 | | | | | | |
| | B3 | | | | | | |
| C: Compatibilizing | C1 | 5 | 5 | 5 | 0.5 | 2 | 2 |
| agent | C2 | | | | | | |
| | C3 | | | | | | |
| Carbon | D1 | | | | | 5 | 5 |
| | D2 | | | | | | |

| | | | | | | |
|---|---|---|---|---|---|---|
| Charpy impact strength | 74 | 66 | 64 | 17 | 12 | 17 |
| Rate of increase | 6.2 | 4.4 | 4.2 | 1.4 | 1.3 | 1.1 |
| Fire retardancy | — | — | — | V-1 | V-0 | V-2 |
| Total burning time (s) | 375 | 372 | 224 | 15 | 17 | 106 |
| Number of firing drips | 2 | 5 | 5 | | | 2 |

TABLE 5

| Comp. Ex. | | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| A: Base resin | A1 | 100 | | | 100 | 100 | 100 | 100 | 100 | 100 | 100 | 100 | 100 | | | 100 | | |
| | A2 | | 100 | | | | | | | | | | | 100 | 100 | | 100 | |
| | A3 | | | 100 | | | | | | | | | | | | | | 100 |
| B: Elastomer | B1 | | | | 4 | | | | | | | 4 | | 4 | | 6 | 6 | 6 |
| | B2 | | | | | 4 | | | | | | | 4 | | 4 | | | |
| | B3 | | | | | | 4 | | | | 4 | | | | | | | |
| C: Compatibilizing | C1 | | | | | | | 2 | | | 2 | | | | | | | |
| agent | C2 | | | | | | | | 2 | | | | | | | | | |
| | C3 | | | | | | | | | 2 | | 2 | 2 | 2 | 2 | | | |
| Carbon | D1 | | | | | | | | | | | | | | | | | |
| | D2 | | | | | | | | | | | | | | | | | |

| | | | | | | | | | | | | | | | | | |
|---|---|---|---|---|---|---|---|---|---|---|---|---|---|---|---|---|---|
| Charpy impact strength | 12 | 9 | 15 | 27 | 29 | 12 | 7 | 15 | 7 | 12 | 17 | 12 | 18 | 9 | 26 | 14 | 52 |
| Rate of increase | 1.0 | 1.0 | 1.0 | 2.2 | 2.4 | 1.0 | 0.6 | 1.3 | 0.6 | 1.0 | 1.4 | 1.0 | 1.9 | 1.0 | 2.1 | 1.6 | 3.5 |
| Fire retardancy | V-0 | V-0 | V-2 | V-1 | V-1 | NG | V-1 | V-1 | V-1 | V-1 | V-1 | V-1 | V-1 | V-1 | V-1 | V-0 | NG |
| Total burning time (s) | 20 | 27 | 50 | 65 | 66 | 83 | 54 | 77 | 60 | 116 | 44 | 86 | 44 | 86 | 38 | 27 | 302 |
| Number of firing drips | | | 5 | | | | | | | | | | | | | | 2 |

From the results of Tables 1 to 5, it is recognized that an increase in the Charpy impact value from the base resin was observed, and thus the impact resistance is high in Examples.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-062211, filed Mar. 19, 2012 and No. 2013-009525, filed Jan. 22, 2013 which are hereby incorporated by reference herein in their entirety.

### INDUSTRIAL APPLICABILITY

The invention can provide a thermoplastic resin composition whose strength is improved from a molded product of a thermoplastic resin which contains an alloy resin of polycarbonate and ABS or AS and which is degraded due to a reduction in the strength.

Therefore, the invention can be utilized for the same fields as those of unused resin, such as electrical home appliances, information technology devices, communication facilities, and automobiles.

1. A polymer composition, which is a polymer composition containing polycarbonate and acrylonitrile-butadiene-styrene or acrylonitrile-styrene, the polymer composition comprising:
a polyester-based thermoplastic elastomer having an ester bond; and
a compatibilizing agent having compatibility with the polycarbonate and the acrylonitrile-butadiene-styrene or the acrylonitrile-styrene,
the compatibilizing agent being represented by Formula II:
—[CH₂CR¹R²]a-[CH₂CR³COOCH₂CH(O)CH]b- (II)
wherein each R¹ to R³ is independently selected from a hydrogen atom, an alkyl group and a phenyl group, and each of the a and b represents an integer of 1 or more.

2. The polymer composition according to claim 1, wherein the content of the thermoplastic elastomer is 0.5 parts by weight or more and 10.0 parts by weight or lower when the total amount of the polycarbonate and the acrylonitrile-butadiene-styrene or the acrylonitrile-styrene is 100 parts by weight.

3. The polymer composition according to claim 1, wherein the content of the thermoplastic elastomer is 1 part by weight or more and 5 parts by weight or lower when the total amount of the polycarbonate and the acrylonitrile-butadiene-styrene or the acrylonitrile-styrene is 100 parts by weight.

4. The polymer composition according to claim 1, wherein the content of the compatibilizing is 0.5 parts by weight or more and 5.0 parts by weight or lower when the total amount of the polycarbonate and the acrylonitrile-butadiene-styrene or the acrylonitrile-styrene is 100 parts by weight.

5. The polymer composition according to claim 1, wherein the content of the compatibilizing is 1.0 part by weight or more and 4.0 parts by weight or lower when the total amount of the polycarbonate and the acrylonitrile-butadiene-styrene or the acrylonitrile-styrene is 100 parts by weight.

6. The polymer composition according to claim 1, wherein the thermoplastic elastomer is a polyether ester elastomer further having an ether bond.

7. (canceled)

8. The polymer composition according to claim 1, wherein the compatibilizing agent is ethylene glycidyl methacrylate.

9. Plastic, comprising:
the polymer composition according to claim 1; and
a flame retardant.

10. An image formation apparatus, comprising:
the plastic according to claim 9 for a housing.

11. An image formation apparatus, comprising:
the plastic according to claim 9 for an interior material.

12. An image pickup apparatus, comprising:
the plastic according to claim 9 for a housing.

13. A display apparatus, comprising:
the plastic according to claim 9 for a housing.

14. A method for manufacturing a polymer composition, comprising:
crushing a molded product containing polycarbonate and acrylonitrile-butadiene-styrene or acrylonitrile-styrene to obtain crushed substances;
mixing a polyester-based thermoplastic elastomer having an ester bond and a compatibilizing agent having compatibility with the polycarbonate and the acrylonitrile-butadiene-styrene or the acrylonitrile-styrene and having an epoxy group in a main chain in the compound with the crushed substances to obtain a mixture; and
melting and kneading the mixture.

15. The method for manufacturing a polymer composition according to claim 14, wherein at least one of the polycarbonate and the acrylonitrile-butadiene-styrene or the acrylonitrile-styrene is a degraded polymer.

16. A method for manufacturing a molded product, comprising:
the method for manufacturing a polymer composition according to claim 14; and
a molding step.

17. The method for manufacturing a molded product according to claim 16, wherein the molding step includes injection molding.

18. The polymer composition according to claim 1,
wherein the polycarbonate and acrylonitrile-butadiene-styrene or acrylonitrilestyrene are degraded resins.

19. The polymer composition according to claim 1,
wherein the polycarbonate and acrylonitrile-butadiene-styrene or acrylonitrilestyrene are recovered molded products.
